(19) United States
(12) Patent Application Publication
(10) Pub. No.: US 2012/0027923 A1
(43) Pub. Date: Feb. 2, 2012

(54) SEAL FOR PHOTOVOLTAIC MODULE

(76) Inventor: Daniel J. Burgard, Wauseon, OH (US)

(21) Appl. No.: 13/192,538

(22) Filed: Jul. 28, 2011

Related U.S. Application Data
(60) Provisional application No. 61/368,503, filed on Jul. 28, 2010.

(51) Int. Cl. B05D 5/00; B05D 5/10; B05D 3/02

(52) U.S. Cl. 427/74

(57) ABSTRACT

A seal can be included in a photovoltaic module to improve reliability and durability.

### CROSS REFERENCE TO RELATED APPLICATION

This application claims priority to provisional application 61/368,503, filed Jul. 28, 2010, which is incorporated by reference herein in its entirety.

### TECHNICAL FIELD

The present invention relates to seals for photovoltaic modules, methods for manufacturing photovoltaic modules, and methods for manufacturing seals.

### BACKGROUND

A photovoltaic module can include a substrate layer and a superstrate layer. To bind the substrate layer to the superstrate layer, a sealant layer can be added between the layers. By improving the quality of the sealant layer, the module's durability and reliability can be improved by providing greater protection against moisture ingress and delamination.

### DESCRIPTION OF DRAWINGS

FIG. 1 is an exploded view of a photovoltaic module.

FIG. 2 is a perspective view of a sealant application process.

FIG. 3 is a top view showing an overlay of a known sealant layer and a new sealant layer.

FIG. 4 is a top view of a known nozzle path and a known sealant layer.

FIG. 5 is a top view of a known nozzle path and a known sealant layer.

FIG. 6 is a perspective view of a photovoltaic module with a known sealant layer.

FIG. 7 is a top view of a new nozzle path and a new sealant layer.

FIG. 8 is a top view of a new nozzle path and a new sealant layer.

FIG. 9 is a perspective view of a photovoltaic module with a new sealant layer.

FIG. 10 is a cross sectional side view of a photovoltaic cell.

FIG. 11 is a flow chart showing a method for manufacturing a photovoltaic module.

FIG. 12 is a flow chart showing a method for generating electricity using a photovoltaic module.

### DETAILED DESCRIPTION

To protect the photovoltaic module from moisture ingress, the sealant layer may be applied near the perimeter of the module. In particular, the sealant layer may be inserted between the superstrate layer and a substrate layer. The sealant layer may serve as an adhesive between the superstrate and substrate layers. However, over time, the sealant layer may fail in bonding the superstrate layer to the substrate layer. For example, as a result of thermal cycling in the field, delamination of the superstrate and substrate may occur proximate to the sealant layer. Delamination is undesirable, since it can lead to premature failure of the module. To improve bonding between the layers and to avoid delamination, a new photovoltaic module and methods of manufacturing photovoltaic modules and sealant layers have been developed and are set forth herein.

In one aspect, a method for manufacturing a photovoltaic module may include providing a first layer including a perimeter and four corner areas. The method may also include forming a sealant layer adjacent to the first layer by dispensing sealant from a nozzle as the nozzle follows a nozzle path proximate to the perimeter of the first layer. The nozzle path may include an acute angle at each of the four corner areas. The method may further include forming a second layer adjacent to the sealant layer. The sealant may include an inner edge and an outer edge. The outer edge may be substantially parallel to the perimeter of the first layer. The outer edge of the sealant layer may be about 0 mm to about 6 mm from the perimeter of the first layer. The first layer may be a superstrate layer, and the second layer may be a substrate layer. Alternately, the first layer may be a substrate layer, and the second layer may be a superstrate layer. The sealant layer may include a flowable rubber. The flowable rubber comprises butyl rubber. The method may include heating the sealant prior to dispensing the sealant. The sealant may be heated to a temperature of about 100° C. to about 200° C. Preferably, the sealant may be heated to a temperature of about 150° C. to about 175° C. The nozzle may travel along the nozzle path at a rate of about 0.1 ft/sec to about 2.0 ft/sec. Preferably, the nozzle may travel along the nozzle path at a rate of about 0.5 ft/sec to about 1.0 ft/sec. The sealant may be dispensed at a flow rate of about 0.1 in 3/sec to about 2.0 in 3/sec. Preferably, the sealant is dispensed at a flow rate of about 0.15 in 3/sec to about 0.3 in 3/sec.

In another aspect, a method for forming a sealant layer may include providing a surface including a perimeter and four corner areas. The method may also include forming a sealant layer adjacent to the surface by dispensing sealant from a nozzle as the nozzle follows a nozzle path proximate to the perimeter of the surface. The nozzle path may include an acute angle at each of the four corner areas. The sealant layer may include an inner edge and an outer edge, and the outer edge may be substantially parallel to the perimeter of the surface. The outer edge of the sealant layer may be about 0 mm to about 6 mm from the perimeter of the surface. The sealant may include a flowable rubber. The method may include heating the sealant prior to dispensing the sealant. The sealant may be heated to a temperature of about 100° C. to about 200° C. The nozzle may travel along the nozzle path at a rate of about 0.1 ft/sec to about 2.0 ft/sec. The sealant may be dispensed at a flow rate of about 0.1 in³/sec to about 2.0 in³/sec.

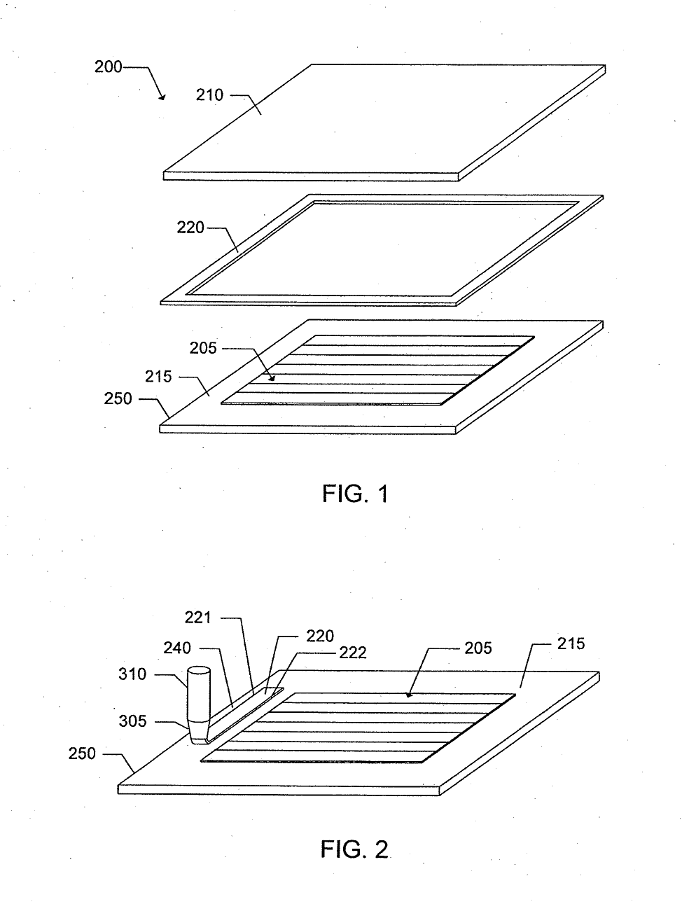

As shown in FIG. 1, a photovoltaic module 200 may include an optically transparent superstrate layer 215. A plurality of solar cells 205 may be formed adjacent to the superstrate layer 215. A sealant layer 220 may be formed between the superstrate layer 215 and a substrate layer 210, where the substrate layer 210 functions as a protective back cover for the module 200. The sealant layer 220 may bind the substrate 210 to the superstrate 215 and serve as a barrier to protect the plurality of solar cells 205 from moisture and debris.

The sealant layer 220 may be disposed between the perimeters of the superstrate layer 210 and the substrate layer 215. During application, the sealant layer 220 may be applied to the superstrate layer 215 as shown in FIG. 2. For example, the sealant layer 220 may be applied to the superstrate layer 215 and then the substrate layer 210 may be positioned against the sealant layer 215. Alternately, the sealant layer 220 may be applied to the substrate layer 210. For example, the sealant layer 220 may be applied to the substrate layer 210 and then the superstrate layer 215 may be positioned against the sealant layer 220.

The sealant layer 220 may provide suitable adhesion properties while also being resistant to degradation resulting from exposure to ultraviolet light. The sealant layer may be applied at room temperature, or it may be heated prior to application to reduce viscosity and improve flow through a nozzle 305, as shown in FIG. 2. For example, the sealant may be heated to a temperature of about 100° C. to about 200° C. Preferably, the sealant may be heated to a temperature of about 150° C. to about 175° C. The sealant may be heated prior to entering the nozzle, while in the nozzle, or a combination thereof. The sealant layer 220 may be any suitable material such as, for example, polyisoprene, silicone, polyurethane, polysulfide, styrene-butadiene rubber (SBR), acrylic or polyacrylate, isoprene, polyisobutylene, vinyl, or nitrile compounds.

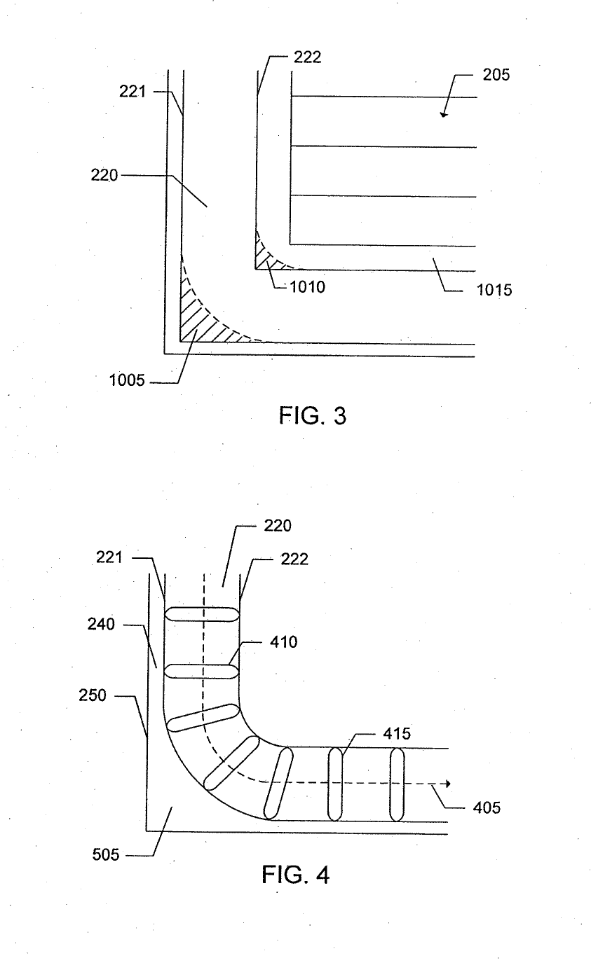

As shown in FIG. 2, a nozzle 305 may be used to apply the sealant layer 220. The nozzle 305 may include an orifice having any suitable shape for dispensing sealant. For example, the orifice shape may be designed to dispense a sealant layer 220 having a tubular shape or a tape-like shape as shown in FIG. 3. The nozzle 305 may be manually controlled, or it may be attached to an automated applicator 310 that is computer-controlled. The nozzle 305 may dispense a continuous bead of sealant around a perimeter of the substrate or superstrate layers (210, 215) to form the sealant layer 220. The sealant may be dispensed at a flow rate of about 0.1 in³/sec to about 2.0 in³/sec. Preferably, the sealant may be dispensed at a flow rate of about 0.15 in³/sec to about 0.3 in³/sec. During the dispensing process, the nozzle may travel at a rate of about 0.1 ft/sec to about 2.0 ft/sec relative to the target layer. Preferably, the nozzle may travel at a rate of about 0.5 ft/sec to about 1.0 ft/sec.

The automated applicator 310 may be programmed to move the nozzle 305 around a perimeter 250 of the superstrate layer 215 and dispense a continuous bead of sealant. When dispensing sealant near the perimeter 250, the nozzle 305 may be programmed to leave a gap 240 between the outer edge 221 of the sealant layer 220 and the perimeter 250 of the superstrate layer 215. The gap 240 may range from about 0 mm to about 6 mm. Preferably, the gap may range from about 1 to about 2 mm. Upon assembly of the module 200, the gap 240 provides an area for the sealant to flow when the sealant layer is laminated between the substrate 210 and superstrate layers 215. As a result, the sealant does not overflow the perimeter 250, so a subsequent edge clean-up step can be avoided.

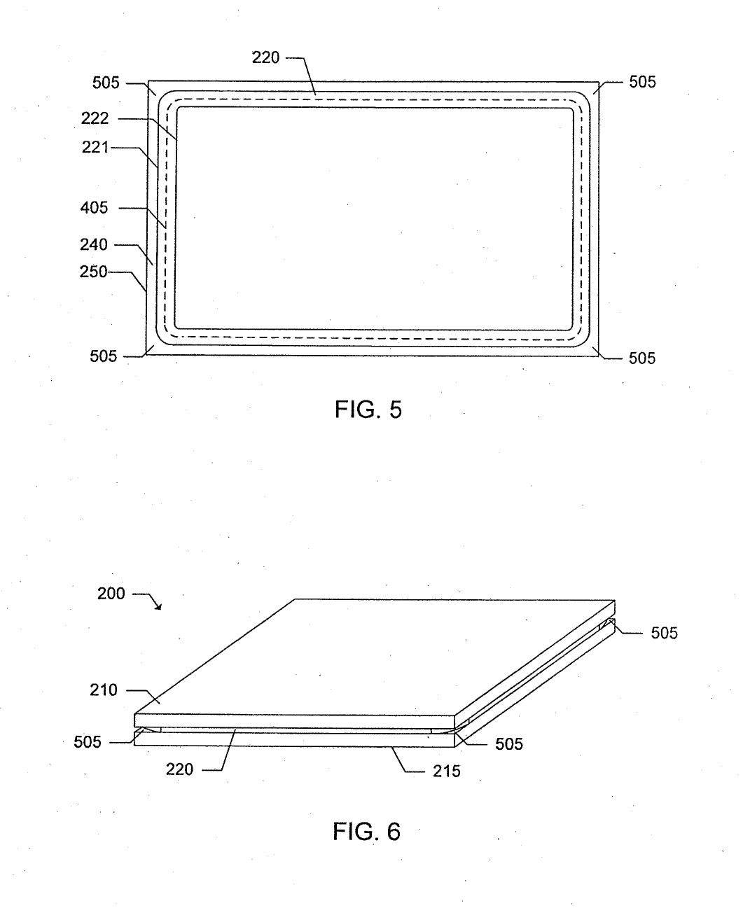

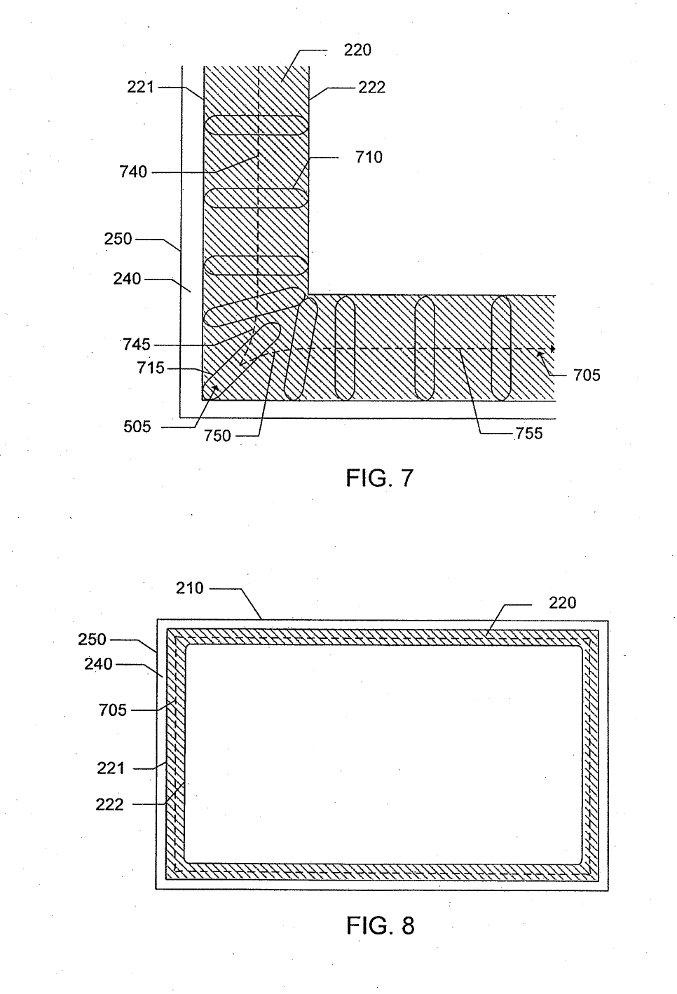

To illustrate the differences between a known process and a new process, FIG. 3 shows an overlay of a known sealant layer and a new sealant layer. The corner of the known sealant layer is shown in dotted lines and was created by following a known nozzle path 405 that is shown in FIGS. 4 and 5. Conversely, the new sealant layer, shown in solid lines, was created by following the new nozzle path 705 shown in FIGS. 7 and 8. Two shaded regions (1005, 1010) highlight differences between the resulting sealant layers. For instance, the first shaded region 1005 shows how corner coverage is improved by following new nozzle path 705. The second shaded region 1010 shows how the new nozzle path results in less encroachment of sealant into the interior surface area 1015 of the substrate or superstrate layer. Due to less encroachment, the plurality of cells 205 may be positioned closer to the sealant layer 220, thereby allowing for more active area within a module having the same outer dimensions. Although FIG. 3 shows an open area between the outer perimeter of the plurality of cells 205 and the inner edge 222 of the sealant layer 220, this is not limiting. For example, the sealant layer may abut or overlap the outer edge of the plurality of cells 205.

Known methods of applying sealant follow a known nozzle path 405, as shown in FIGS. 4 and 5. The nozzle path 405 is shown as a dotted line. When following the known nozzle path 405, the nozzle 305 travels in a straight line and, upon reaching a corner, the nozzle 305 rotates 90 degrees counterclockwise while its direction of travel also rotates 90 degrees counterclockwise. As a result, an arc of sealant is dispensed near the corner. In FIG. 4, seven exemplary nozzle positions (e.g. 410, 415) are shown. The nozzle path 405 intersects the midpoint of each nozzle position along the nozzle path 405.

As shown in FIG. 5, upon turning 90 degrees near a first corner, the nozzle path 405 continues in a straight line until it reaches the next corner where it again rotates 90 degrees counterclockwise as described above. Upon traveling around the perimeter of the substrate or superstrate layer, the sealant layer 220 is created as shown in FIG. 5. Unfortunately, since the nozzle 305 scribes an arc near each of the four corners, sealant is not distributed out to the corner areas 505 of the superstrate or substrate layers. As a result, surface area that could be used for bonding is left unutilized. To further illustrate this point, FIG. 6 shows a perspective view of a module 200 where the sealant layer 220 does not extend to the corner areas 505 of the substrate or superstrate layers. In addition to forming a weak bond, the configuration shown in FIG. 6 is undesirable because water may enter the corner voids and freeze, thereby causing delamination between the module's layers. Furthermore, the corners of the substrate and superstrate layers may be prone to breakage where there is no support from the sealant layer. Therefore, it is desirable to add sealant to the corner areas 505 without adding any additional steps to the manufacturing process, since additional steps can add cost and complexity to the process.

FIGS. 7 and 8 depict a new nozzle path 705. In particular, FIG. 7 shows the nozzle path 705 in detail near one corner of the target layer (e.g. 210, 215). The nozzle path 705 is depicted as a dashed line. When the nozzle 305 follows the nozzle path 705, sealant is distributed to the corner areas of the layer without adding any additional steps to the manufacturing process. A sealant layer 220 is formed having an inner edge 222 and an outer edge 221. Although the nozzle path 705 is described with respect to a counterclockwise travel path herein, a clockwise travel path, or combination thereof, may also be used.

To illustrate the dispensing process, exemplary nozzle positions (e.g. 710, 715) are shown along the nozzle path 705. The nozzle path 705 is defined as a path that intersects the midpoint of each nozzle position (e.g. 710, 715). The nozzle first travels along a straight path 740 towards the corner area 505. As the nozzle approaches the corner are 505, the nozzle 305 begins to rotate counterclockwise. Simultaneously, the nozzle path 705 deviates from its straight path 740 towards the corner area 505 along an arced path 745. Upon rotating 45 degrees counterclockwise and entering the corner area 505, the nozzle 305 withdraws from the corner area 505 and travels along a second arced path 750 before continuing along a second straight path 755. The second straight path is substantially perpendicular to the straight path taken when approaching the corner area 505. As shown in FIG. 8, the nozzle path 705 has a shape that resembles a rectangle. However, the nozzle path differs from a rectangle because the corners of the nozzle path 705 are acute angles instead of right angles.

Upon traveling around the entire perimeter of the substrate or superstrate layer, a sealant layer 220 is produced as shown in FIG. 8, where the sealant extends toward the corner area of the substrate or superstrate layer. As noted above, the sealant layer 220 may have an outer edge 221 and an inner edge 222. The outer edge 222 of the sealant layer 220, as shown in FIG. 8, may be approximately rectangular. In other words, the outer corners of the sealant layer 220 have little or no radius, so they are nearly right angles when compared to the rounded corners of the sealant layer shown in FIG. 5.

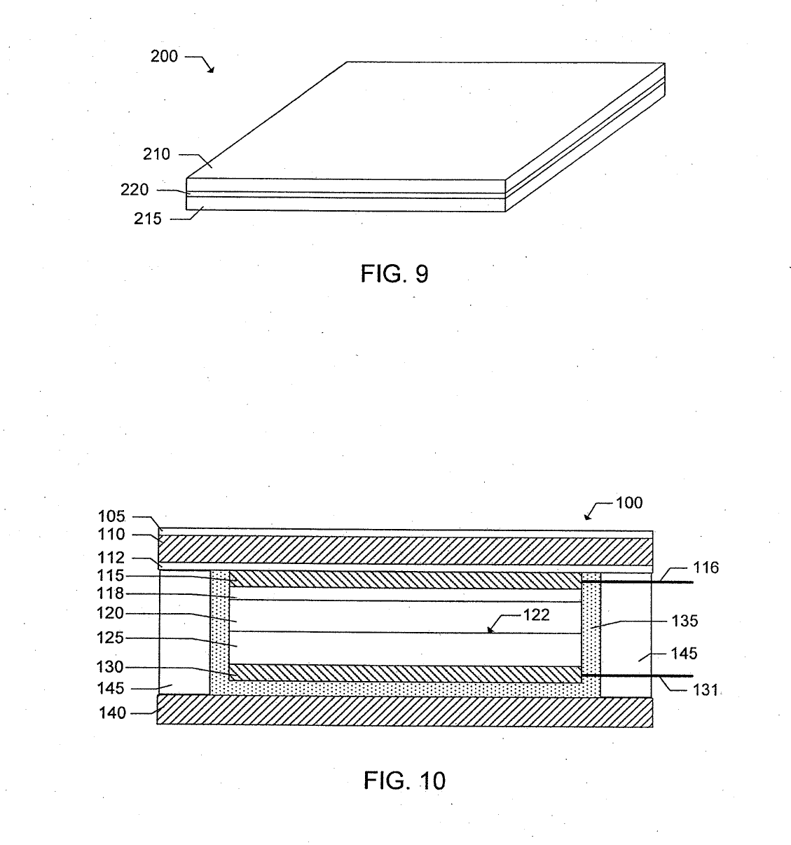

FIG. 9 shows a module 200 that includes the new sealant layer 220 using the new nozzle path 705. Unlike the module shown in FIG. 5, the module 200 in FIG. 9 has no corner voids. As a result, bonding between the substrate layer 215 and the superstrate 210 layers is improved, and the module 200 is less susceptible to delamination and breakage.

FIG. 1 shows a photovoltaic module 200 containing a simplified example of a plurality of photovoltaic cells. To provide greater detail about the cells, FIG. 10 depicts a cross-sectional view of an example photovoltaic cell. In particular, the photovoltaic cell 100 may include an anti-reflective coating 105 formed on a superstrate 110. The anti-reflective coating 105 may be designed to reduce reflection and increase transmission. For instance, reflections are minimized if the coating is approximately one-quarter-wavelength thick with respect to the wavelengths of incident photons. Since CdTe has a bandgap energy of 1.48 eV, the anti-reflective coating 105 may have a thickness of about 0.15 microns. The anti-reflective coating 105 may contain, for example, aluminum oxide, titanium dioxide, magnesium oxide, silicon monoxide, silicon dioxide, or tantalum pentoxide. Since the anti-reflective coating only optimizes transmission at a single wavelength, it may be desirable to modify the surface of the superstrate 110 to improve overall transmission. For instance, the superstrate 110 may be textured prior to adding the anti-reflective coating 105 to enhance light trapping.

The superstrate 110 may be formed from an optically transparent material such as soda-lime glass. Since quality and cleanliness of a glass superstrate can have a significant effect on performance of the device, polishing the glass with cerium oxide powder may be desirable to increase transmission. A barrier layer 112 may be formed adjacent to the superstrate 110 to lessen diffusion of sodium or other contaminants from the superstrate 110. The barrier layer 112 may include silicon dioxide or any other suitable material.

A transparent conductive oxide (TCO) layer 115 may be formed between the barrier layer 112 and a buffer layer 120 and may serve as a front contact for the photovoltaic device. In forming the TCO layer 115, it is desirable to use a material that is both highly conductive and highly transparent. For example, the TCO layer 115 may include tin oxide, cadmium stannate, or indium tin oxide. To further improve transparency, the TCO layer 115 may be about 1 micron thick. If cadmium stannate is used, application of the cadmium stannate may be accomplished by mixing cadmium oxide with tin dioxide using a 2:1 ratio and depositing the mixture onto the superstrate 110 using radio frequency magnetron sputtering. A buffer layer 118 may be formed between the TCO layer 115 and a n-type window layer 120 to decrease the likelihood of irregularities occurring during formation of the n-type window layer.

The n-type window layer 120 may include a very thin layer of cadmium sulfide. For instance, the n-type window layer 120 may be 0.1 microns thick and may be deposited using any suitable thin-film deposition technique. For example, the n-type window layer 120 may be deposited using a metal organic chemical vapor deposition (MOCVD). To reduce surface roughness of the n-type window layer 120, it may be annealed at approximately 400 degrees Celsius for about 20 minutes. The annealing process may improve the boundary between the n-type window layer 120 and the CdTe layer 125 by reducing defects. By reducing defects and improving the boundary, the efficiency of the photovoltaic device is improved.

The p-type absorber layer 125 may be formed adjacent to the n-type window layer 120 and may include cadmium telluride. The p-type absorber layer 125 may be deposited using any suitable deposition method. For instance, the p-type absorber layer 125 may be deposited using atmospheric pressure chemical vapor deposition (APCVD), sputtering, atomic layer epitaxy (ALE), laser ablation, physical vapor deposition (PVD), close-spaced sublimation (CSS), electrodeposition (ED), screen printing (SP), spray, or MOCVD. Following deposition, the p-type absorber layer 125 may be heat treated at a temperature of about 420 degrees Celsius for about 20 minutes in the presence of cadmium chloride, thereby improving grain growth and reducing grain boundary trapping effects on minority carriers. By reducing trapping effects within the p-type absorber layer 125, open-circuit voltage is increased.

A p-n junction 122 is formed where the p-type absorber layer 125 meets the n-type window layer 120. The p-n junction 122 contains a depletion region characterized by a lack of electrons on the n-type side of the junction and a lack of holes (i.e. electron vacancies) on the p-type side of the junction. The width of the depletion region is equal to the sum of the diffusion depths located on the p-type side and the n-type side. The respective lack of electrons and holes is caused by electrons diffusing from the n-type window layer 120 to the p-type absorber layer 125 and holes diffusing from the p-type absorber layer 125 to the n-type window layer 120. As a result of the diffusion process, positive donor ions are formed on the n-type side and negative acceptor ions are formed on the p-type side. The positive donor ions may be phosphorous atoms locked in a silicon lattice that have donated an electron, and the negative acceptor ions may be boron atoms locked in a silicon lattice that have gained an electron. The presence of a negative ion region near a positive ion region establishes a built-in electric field across the p-n junction 122. When the photovoltaic device 100 is exposed to sunlight, photons are absorbed within the junction region. As a result, photo-generated electron-hole pairs are created. Movement of the electron-hole pairs are influenced by the built-in electric field, which produces current flow. The current flow occurs between a first terminal 116 attached to the TCO layer 115 and a second terminal 131 attached to a back contact 130.

The back contact 130 may be formed adjacent to the p-type absorber layer 125. The back contact 130 may be a low-resistance ohmic contact that maintains good contact with the p-type absorber layer 125 throughout temperature cycling. To ensure stability of the contact, a rear surface of the p-type absorber layer 125 may be etched with nitric-phosphoric (NP) to create a layer of elemental Te on the rear surface, and the back contact 130 may cover the entire back surface of the p-type absorber layer 125. The back contact 130 may include aluminum applied through evaporation that is subsequently annealed. Alternately, the back contact 130 may include molybdenum or any other suitable low-resistance material.

The various layers formed between the superstrate layer 110 and substrate layer 140 may be covered by an interlayer 135. For example, the interlayer 135 may cover the TCO layer, buffer layer, n-type window layer, p-type absorber layer, and back contact 130 as shown in FIG. 10. The interlayer 135 may protect the layers from moisture and water ingress and may provide containment of potentially harmful materials if the photovoltaic device is physically damaged. The interlayer 135 may include a polymer material such as, for example, ethylene-vinyl acetate (EVA), but any other suitable material may be used. To form the interlayer 135, the previously formed layers may be laminated with a sheet of EVA.

A sealant layer 145, as described above, may be formed around the perimeter of the interlayer 135. Lastly, the substrate 140 may be formed adjacent to the interlayer 135 and may further protect the rear side of the device. The protective back substrate 1.40 may include any suitable material such as, for example, soda-lime glass, plastic, carbon fiber, or resin.

As shown in FIG. 11, a method for manufacturing a photovoltaic module may include providing a first layer 1105 of a photovoltaic module. The first layer may be a substrate or superstrate layer. In addition, the first layer may be an optically transparent material, such as soda lime glass. The method may further include forming a sealant layer adjacent to the first layer by dispensing sealant from a nozzle along a nozzle path 1110 as shown in FIGS. 7 and 8. The method may further include forming a second layer adjacent to the sealant layer 1115. The second layer may be a substrate or superstrate layer. In addition, the second layer may be an optically transparent material, such as soda lime glass.

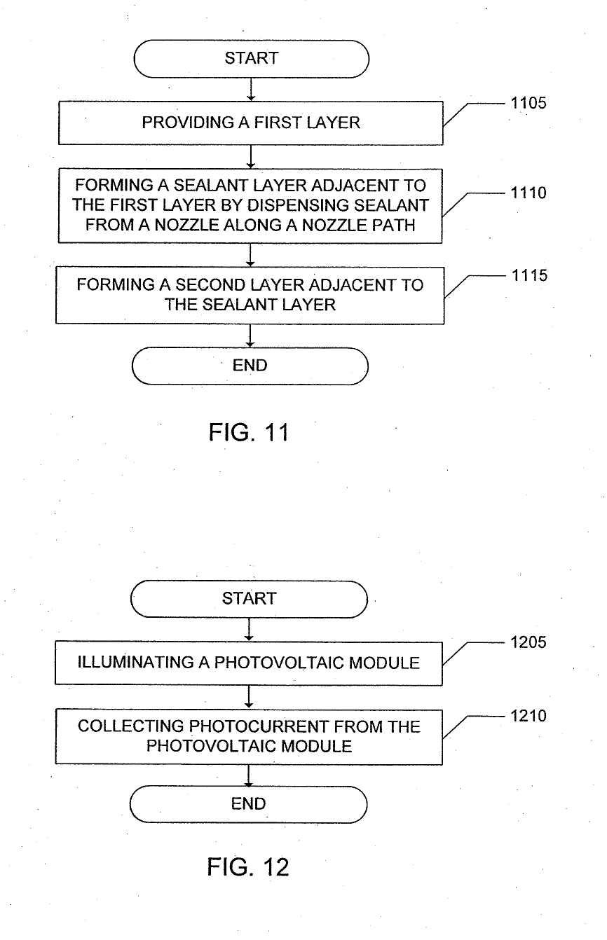

As shown in FIG. 12, a method for generating electricity may include illuminating a photovoltaic module 1205 to generate a photocurrent. The method may further include collecting the photocurrent from the photovoltaic module 1210. “Collecting” may refer to storage or using the current. For example, “collecting” may refer to storing the current in a storage device, such as a battery. Alternately, “collecting” may refer to using the current to power an electrical load.

Details of one or more embodiments are set forth in the accompanying drawings and description. Other features, objects, and advantages will be apparent from the description, drawings, and claims. Although a number of embodiments of the invention have been described, it will be understood that various modifications may be made without departing from the spirit and scope of the invention. In particular, steps depicted in the figures may be executed in orders differing from the orders depicted. For example, steps may be performed concurrently or in alternate orders from those depicted. It should also be understood that the appended drawings are not necessarily to scale, presenting a somewhat simplified representation of various features and basic principles of the invention.

What is claimed is:

1. A method for manufacturing a photovoltaic module, the method comprising:
providing a first layer comprising a perimeter and four corner areas;
forming a sealant layer adjacent to the first layer by dispensing sealant from a nozzle as the nozzle follows a nozzle path proximate to the perimeter of the first layer, wherein the nozzle path comprises an acute angle at each of the four corner areas; and
forming a second layer adjacent to the sealant layer.

2. The method of claim 1, wherein the sealant comprises an inner edge and an outer edge, and wherein the outer edge is substantially parallel to the perimeter of the first layer.

3. The method of claim 2, wherein the outer edge of the sealant layer is about 0 mm to about 6 mm from the perimeter of the first layer.

4. The method of claim 1, wherein the first layer is a superstrate layer, and wherein the second layer is a substrate layer.

5. The method of claim 1, wherein the first layer is a substrate layer, and wherein the second layer is a superstrate layer.

6. The method of claim 1, wherein the sealant layer comprises a flowable rubber.

7. The method of claim 6, wherein the flowable rubber comprises butyl rubber.

8. The method of claim 1, further comprising heating the sealant prior to dispensing the sealant.

9. The method of claim 8, wherein the sealant is heated to a temperature of about 100° C. to about 200° C.

10. The method of claim 8, wherein the sealant is heated to a temperature of about 150° C. to about 175° C.

11. The method of claim 1, wherein the nozzle travels along the nozzle path at a rate of about 0.1 ft/sec to about 2.0 ft/sec.

12. The method of claim 1, wherein the nozzle travels along the nozzle path at a rate of about 0.5 ft/sec to about 1.0 ft/sec.

13. The method of claim 1, wherein the sealant is dispensed at a flow rate of about 0.1 in³/sec to about 2.0 in³/sec.

14. The method of claim 1, wherein the sealant is dispensed at a flow rate of about 0.15 in³/sec to about 0.3 in³/sec.

15. A method for forming a sealant layer, the method comprising:
providing a surface comprising a perimeter and four corner areas; and
forming a sealant layer adjacent to the surface by dispensing sealant from a nozzle as the nozzle follows a nozzle path proximate to the perimeter of the surface, wherein the nozzle path comprises an acute angle at each of the four corner areas.

16. The method of claim 15, wherein the sealant layer comprises an inner edge and an outer edge, and wherein the outer edge is substantially parallel to the perimeter of the surface.

17. The method of claim 16, wherein the outer edge of the sealant layer is about 0 mm to about 6 mm from the perimeter of the surface.

18. The method of claim 15, wherein the sealant comprises a flowable rubber.

19. The method of claim 1, further comprising heating the sealant prior to dispensing the sealant, wherein the sealant is heated to a temperature of about 100° C. to about 200° C.

20. The method of claim 15, wherein the nozzle travels along the nozzle path at a rate of about 0.1 ft/sec to about 2.0 ft/sec.

21. The method of claim 15, wherein the sealant is dispensed at a flow rate of about 0.1 in³/sec to about 2.0 in³/sec.
